(19) United States
(12) Patent Application Publication
(10) Pub. No.: US 2025/0285361 A1
(43) Pub. Date: Sep. 11, 2025

(54) INFORMATION PROCESSING DEVICE

(71) Applicant: TOYOTA JIDOSHA KABUSHIKi KAISHA, Toyota-shi (JP)

(72) Inventor: Miki TSUJINO, Ichinomiya-shi (JP)

(73) Assignee: TOYOTA JIDOSHA KABUSHIKI KAISHA, Toyota-shi (JP)

(21) Appl. No.: 19/010,664

(22) Filed: Jan. 6, 2025

(30) Foreign Application Priority Data
Mar. 6, 2024 (JP) 2024-034291

(51) Int. Cl. G06T 15/10; G06V 20/58

(52) U.S. Cl. CPC G06T 15/10; G06V 20/58; G06V 2201/08

(57) ABSTRACT

The information processing device includes a control unit that causes a display unit to display an image indicating the host vehicle and the surroundings when viewed from a virtual viewpoint on the basis of surroundings information regarding surroundings of the host vehicle, and causes the display unit to display an image indicating the registered vehicle in a manner different from an image indicating another vehicle different from the registered vehicle when the registered vehicle is detected.

### CROSS-REFERENCE TO RELATED APPLICATION

This application claims priority to Japanese Patent Application No. 2024-034291 filed on Mar. 6, 2024, incorporated herein by reference in its entirety.

### BACKGROUND

### 1. Technical Field

The present disclosure relates to information processing devices.

### 2. Description of Related Art

Japanese Patent No. 7048398 (JP 7048398 B) discloses a technique in which an image showing a plurality of other vehicles is displayed on a display unit.

### SUMMARY

However, in the technique of JP 7048398 B, images showing a plurality of other vehicles are displayed on the display unit in the same manner, and it is not possible to make an occupant of a host vehicle aware of the presence of a specific other vehicle via a display unit.

It is therefore an object of the present disclosure to provide an information processing device that can make an occupant of a host vehicle aware of the presence of a specific other vehicle via a display unit.

An information processing device of claim 1 includes a control unit. The control unit is configured to cause a display unit to display an image showing a host vehicle and surroundings of the host vehicle as viewed from a virtual viewpoint, based on surroundings information regarding the surroundings, and is configured to, when a registered vehicle registered in advance is detected, cause the display unit to display an image showing the registered vehicle in a manner different from a manner in which the display unit displays an image showing another vehicle different from the registered vehicle.

In the information processing device of claim 1, the control unit causes the display unit to display the image showing the host vehicle and the surroundings as viewed from the virtual viewpoint, based on the surroundings information. When the registered vehicle is detected based on the surroundings information, the control unit causes the display unit to display the image showing the registered vehicle in a manner different from the manner in which the display unit displays the image showing another vehicle different from the registered vehicle. The information processing device can thus make an occupant of the host vehicle aware of the presence of the registered vehicle by causing the display unit to display the image showing the registered vehicle in a manner different from the image showing the other vehicle.

According to an information processing device of claim 2, in claim 1, the control unit may be configured to, when the image showing the registered vehicle becomes unable to be displayed on the display unit based on the surroundings information, erase the image showing the registered vehicle from the display unit and cause the display unit to display location information regarding a current location of the registered vehicle acquired by a communication function to perform communication between the registered vehicle and the host vehicle.

In the information processing device of claim 2, when the image showing the registered vehicle becomes unable to be displayed on the display unit based on the surroundings information, the control unit erases the image showing the registered vehicle from the display unit and causes the display unit to display the location information regarding the current location of the registered vehicle acquired by the communication function. The information processing device can thus continue to make the occupant of the host vehicle aware of the current location of the registered vehicle even when the image showing the registered vehicle becomes unable to be displayed on the display unit.

According to an information processing device of claim 3, in claim 1 or 2, the control unit may be configured to, when the image showing the registered vehicle becomes unable to be displayed on the display unit based on the surroundings information, erase the image showing the registered vehicle from the display unit and cause the display unit to display trajectory information regarding a travel trajectory of the registered vehicle acquired by a communication function to perform communication between the registered vehicle and the host vehicle.

In the information processing device of claim 3, when the image showing the registered vehicle becomes unable to be displayed on the display unit based on the surroundings information, the control unit erases the image showing the registered vehicle from the display unit and causes the display unit to display the trajectory information regarding the travel trajectory of the registered vehicle acquired by the communication function. The information processing device can thus track the registered vehicle even when the image showing the registered vehicle becomes unable to be displayed on the display unit.

According to an information processing device of claim 4, in any one of claims 1 to 3, the information processing device may further include a contact unit configured to take a predetermined measure to contact an occupant of the registered vehicle, based on an operation on the image showing the registered vehicle that is displayed on the display unit that also serves as an operation unit.

In the information processing device of claim 4, the contact unit takes the predetermined measure to contact the occupant of the registered vehicle, based on the operation on the image showing the registered vehicle that is displayed on the display unit that also serves as the operation unit. The information processing device can thus easily contact the occupant of the registered vehicle via the display unit.

According to an information processing device of claim 5, in any one of claims 1 to 4, the information processing device may further include a communication unit configured to send another-vehicle information indicating the other vehicle designated based on an operation on the display unit that also serves as an operation unit to the registered vehicle by a communication function to perform communication between the registered vehicle and the host vehicle.

In the information processing device of claim 5, the communication unit sends the other-vehicle information indicating the other vehicle designated based on the operation on the display unit that also serves as the operation unit to the registered vehicle by the communication function. The information processing device can thus make the occupant of the registered vehicle aware of the presence of a specific other vehicle.

As described above, the information processing device according to the present disclosure can make the occupant of the host vehicle aware of the presence of a specific other vehicle via the display unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a hardware configuration of a vehicle;

FIG. 2 is a flowchart illustrating a flow of a specific process;

FIG. 3 is a first display example displayed on a monitor;

FIG. 4 is a second display example displayed on a monitor;

FIG. 5 is a third exemplary display displayed on a monitor; and

FIG. 6 is a fourth display example displayed on the monitor.

### DETAILED DESCRIPTION OF EMBODIMENTS

Hereinafter, the vehicle 10 according to the present embodiment will be described.

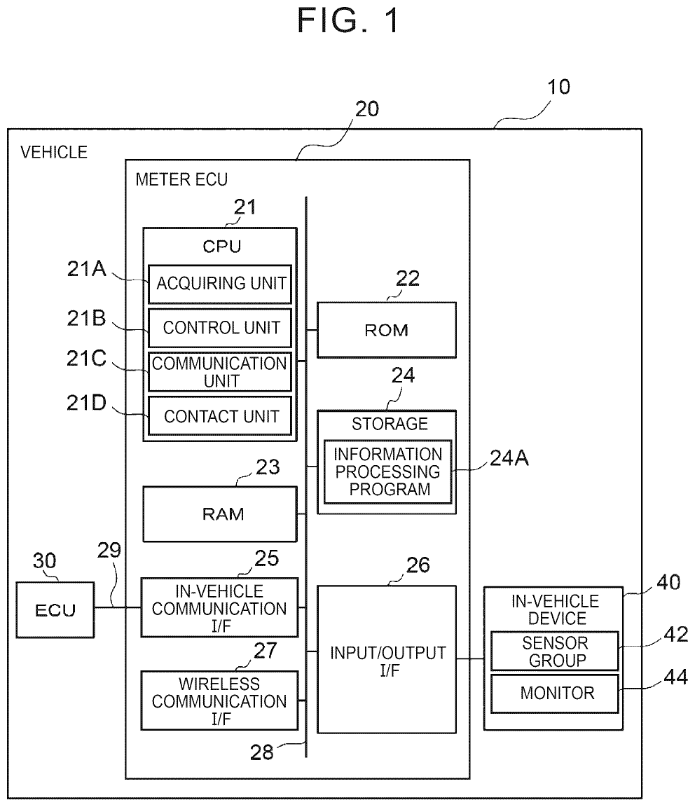

FIG. 1 is a block diagram illustrating a hardware configuration of a vehicle 10. As illustrated in FIG. 1, the vehicles 10 include a meter ECU (Electronic Control Unit) 20. The vehicle 10 is an example of a “host vehicle”, and the meter ECU 20 is an example of an “information processing device”.

The meter ECU 20 includes CPU (Central Processing Unit) 21, ROM (Read Only Memory) 22, and RAM (Random Access Memory) 23. The meter ECU 20 includes a storage 24, an in-vehicle communication I/F (Interface) 25, an input/output I/F 26, and a radio communication I/F 27. CPU 21, ROM 22, RAM 23, the storage 24, the in-vehicle communication I/F 25, the input/output I/F 26, and the radio communication I/F 27 are communicably connected to each other via an inner bus 28.

CPU 21 is a central processing unit that executes various programs and controls each unit. That is, CPU 21 reads the program from ROM 22 or the storage 24, and executes the program using RAM 23 as a working area. CPU 21 performs control of the above-described configurations and various arithmetic processes in accordance with programs recorded in ROM 22 or the storage 24.

ROM 22 stores various programs and various data. RAM 23 temporarily stores a program/data as a working area.

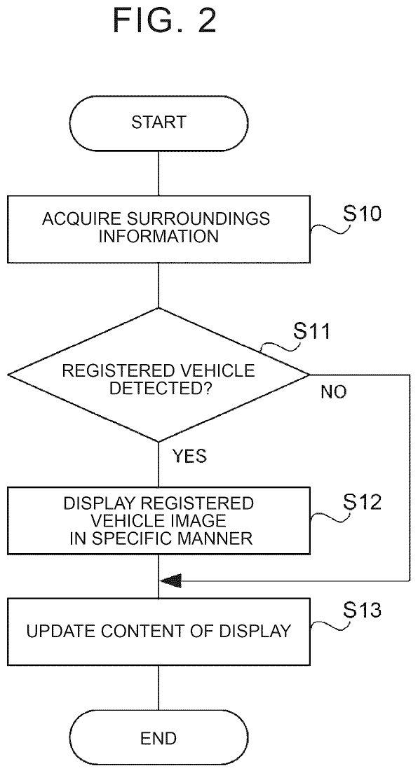

The storage 24 is constituted by a storage device such as a eMMC (embedded Multi Media Card) or a UFS (Universal Flash Storage), and stores various programs and various data. The storage 24 stores information processing program 24A. The information processing program 24A is a program for causing CPU 21 to execute a specifying process (see FIG. 2), which will be described later.

The in-vehicle communication I/F 25 is an interface for connecting to another ECU 30. The interface uses a CAN protocol-based communication standard. The in-vehicle communication I/F 25 is connected to an external bus 29. Although not shown, a plurality of ECU is provided for each function of the vehicles 10 in addition to ECU 30.

The input/output I/F 26 is an interface for communicating with the in-vehicle device 40 mounted on the vehicle 10.

The in-vehicle device 40 is a variety of devices mounted on the vehicle 10. The vehicle 10 includes a sensor group 42 and a monitor 44 as an example of the in-vehicle device 40.

The sensor group 42 includes, for example, a 3D-LiDAR, a millimeter-wave sensor, an infra-red sensor, a winker sensor, an accelerator position sensor, a vehicle speed sensor, a steering angle sensor, an angular velocity sensor, and a GPS (Global Positioning System) sensor. The sensor group 42 includes, for example, a sensor for detecting a state of the vehicle 10 and surroundings, such as an illuminance sensor, a gyro sensor, and an acceleration sensor, and a plurality of cameras for capturing an image of the periphery of the vehicle 10. The sensor group 42 outputs images captured by the respective sensors and images captured by the respective cameras to the meter ECU 20, ECU 30, and the like.

The monitor 44 is a liquid crystal monitor provided on a meter panel disposed in front of a driver's seat of the vehicle 10 and for displaying an operation proposal related to the function of the vehicle 10, an image related to the explanation of the function, and the like. The monitor 44 integrally includes a touch panel and also serves as an operation unit that can be operated by an occupant of the vehicle 10. The monitor 44 is an example of a “display unit”.

The wireless communication I/F 27 is a wireless communication module for communicating with an external device. As the radio communication module, for example, communication standards such as 5G, LTE, Wi-Fi (registered trademark) and Bluetooth (registered trademark) are used.

CPU 21 of the meter ECU 20 includes, as functional components, an acquiring unit 21A, a control unit 21B, a communication unit 21C, and a contact unit 21D. The respective functional configurations are realized by CPU 21 reading and executing the information processing program 24A stored in the storage 24.

The acquiring unit 21A acquires various types of data. For example, the acquiring unit 21A acquires, as various types of information, surroundings information regarding the surroundings of the vehicles 10. The surroundings information includes a detection result of each sensor constituting the sensor group 42, an image captured by each camera, and the like.

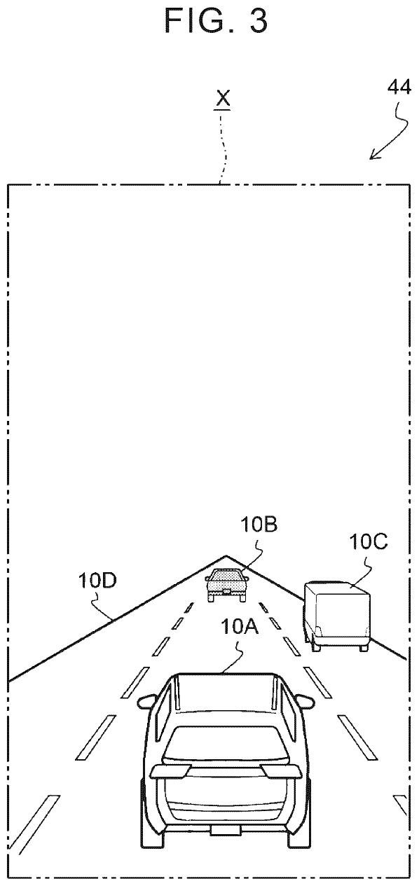

The control unit 21B performs display control related to the display of the monitor 44. For example, the control unit 21B causes the monitor 44 to display, as the display control, the host vehicle image 10A (see FIG. 3 and the like) which is an image showing the vehicle 10 when viewed from the virtual viewpoint and the surroundings image which is an image showing the surroundings of the vehicle 10, on the basis of the surroundings information acquired by the acquiring unit 21A. The virtual viewpoint is set on a three-dimensional virtual space whose origin is the position of the host vehicle image 10A, and is defined by viewpoint coordinates and viewpoint angles (orientations) on the virtual space. For example, the virtual viewpoint is a viewpoint viewed at a specific viewpoint angle from a specific viewpoint coordinate on the upper side of the host vehicle image 10A in the virtual space.

Further, the surroundings image includes a road image indicating a road including a roadway and a sidewalk on which the vehicle 10 travels, and a target image indicating a target other than the vehicle 10 such as another vehicle and a pedestrian. The road shown in the road image includes public roads, private roads, empty spaces, square spaces, parking lots, and the like.

The communication unit 21C realizes a communication function with other vehicles by using a radio communication I/F 27. The communication function realizes an inter-vehicle communication system in which the vehicle 10 and other vehicles communicate with each other to directly exchange information on the state and surroundings of each vehicle. For example, according to the inter-vehicle communication system, the vehicle 10 can acquire information on the current location of another vehicle, information on the travel trajectory, and the like. Further, according to the inter-vehicle communication system, the vehicle 10 can notify another vehicle of the presence of a specific other vehicle (e.g., an emergency vehicle).

The contact unit 21D takes a predetermined measure to contact an occupant of the registered vehicles registered in advance. An occupant of the vehicle 10 inputs registered vehicle information such as a vehicle name, a vehicle type, a dimension, a shape, a color, an automobile registration number, and contact information of an occupant of the registered vehicle by an input operation using an input interface (not shown), and registers the registered vehicle in advance. The registered vehicle information is stored in the storage 24. Further, the predetermined measure includes a call, a mail, a message, and the like. In the present embodiment, the contact unit 21D performs a hands-free call to the telephone number of the occupant of the registered vehicle indicated by the registered vehicle information as the predetermined measure.

FIG. 2 is a flow chart illustrating a flow of a specifying process executed by the meter ECU 20. CPU 21 reads the information processing program 24A from the storage 24, develops it in RAM 23, and executes it, thereby performing the specifying process. As an example, the identification processing is performed repeatedly and automatically every time a certain period of time elapses.

In S10 illustrated in FIG. 2, CPU 21 acquires the surroundings information regarding the surroundings of the vehicles 10. Then, CPU 21 proceeds to S11.

In S11, CPU 21 determines whether or not the registered vehicles have been detected based on the surroundings information acquired in S10. Here, if it is determined that the registered vehicles have been detected (S11: YES), CPU 21 proceeds to S12. On the other hand, when CPU 21 determines that the registered vehicles have not been detected (S11: NO), the process proceeds to S13. As an example, CPU 21 determines that the registered vehicle has been detected when the same number as the vehicle registration number indicated in the registered vehicle information stored in the storage 24 can be recognized from the images captured by the cameras constituting the sensor group 42.

In S12, CPU 21 displays the registered vehicle image 10B (see FIG. 3 and the like) which is an image indicating the registered vehicle on the monitor 44 in a particular manner. A particular aspect is a dedicated design configured for a registered vehicle. The specific mode may be set by an occupant of the vehicle 10, or may be prepared in advance. Then, CPU 21 proceeds to S13.

In S13, CPU 21 updates the content displayed on the monitor 44 based on the surroundings information acquired in S10. For example, CPU 21 narrows the inter-vehicle distance between the host vehicle image 10A on the monitor 44 and the registered vehicle image 10B when the vehicle 10 approaches the registered vehicle ahead. Then, CPU 21 ends the identifying process.

Next, an exemplary displaying of the host vehicle image 10A and the surroundings image on the monitor 44 will be described with reference to FIGS. 3 to 6.

FIG. 3 is a first explanatory diagram illustrating a display example displayed in the display area X of the monitor 44. The display area X is a partial area of the monitor 44, and the occupant seated in the driver's seat can be visually recognized through the opening of the steering wheel.

In the display area X shown in FIG. 3, the host vehicle image 10A and the registered vehicle image 10B, the other-vehicle image 10C, and the road image 10D are displayed as the surroundings image. These images are displayed in the display area X from the viewpoint viewed from the above-described virtual viewpoint. The registered vehicle image 10B is an image indicating a registered vehicle located forward of the same lane as the vehicle 10. The other-vehicle image 10C is an image indicating a different vehicle than the registered vehicle located on the forward side of the right lane of the vehicle 10. In other words, the other-vehicle image 10C is an image indicating another vehicle that is not registered as a registered vehicle in the vehicle 10. The road image 10D is an image indicating a road on which the vehicles 10 are traveling.

Here, CPU 21 of the meter ECU 20 displays the host vehicle image 10A, the registered vehicle image 10B, and the other-vehicle image 10C on the road image 10D based on the acquired surroundings information. For example, as illustrated in FIG. 3, CPU 21 causes the registered vehicle image 10B to be displayed on the same lane as the host vehicle image 10A in the road image 10D, and causes the other-vehicle image 10C to be displayed on the right lane of the host vehicle image 10A in the road image 10D.

In addition, CPU 21 assigns a dedicated pattern to the registered vehicle image 10B as the above-described particular aspect. On the other hand, CPU 21 does not give any pattern to the other-vehicle-image 10C and expresses it in white. As shown in FIG. 3, the visibility of the registered vehicle image 10B is enhanced by displaying the registered vehicle image 10B on the monitor 44 in a manner that differs from the other-vehicle image 10C. Note that the above-described different aspects are not limited to changing the pattern of the image, and may be, for example, changing the color of the image or displaying the image in a dedicated shape.

Further, CPU 21 executes a hands-free call to the occupant of the registered vehicle on the basis of an operation on the registered vehicle image 10B displayed on the monitor 44, for example, a touch operation by the finger of the occupant of the vehicle 10.

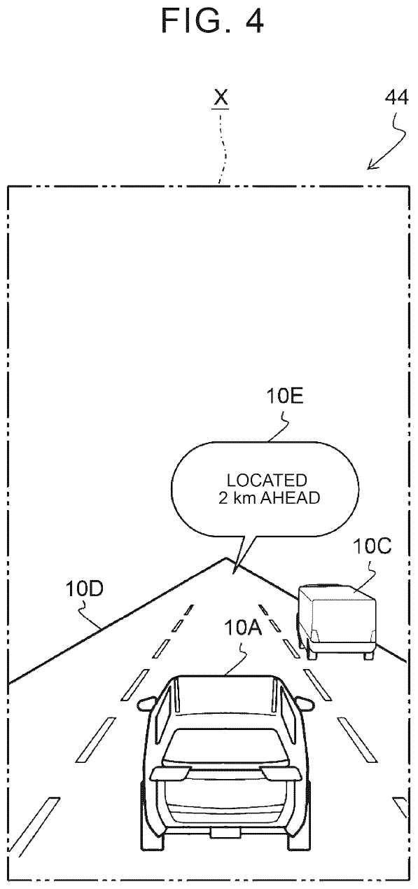

FIG. 4 is a second explanatory diagram illustrating a display example displayed in the display area X of the monitor 44.

In the display area X illustrated in FIG. 4, the registered vehicle image 10B cannot be displayed on the monitor 44 on the basis of the surroundings information by the vehicle 10, and thus the registered vehicle image 10B is deleted. When the registered vehicle image 10B cannot be displayed on the monitor 44 on the basis of the surroundings information, it includes a case where the vehicle 10 cannot detect the registered vehicle from the surroundings information, a case where the location of the registered vehicle detected based on the surroundings information is out of the display area of the monitor 44, and the like.

Here, the vehicle 10 and the registered vehicle perform vehicle-to-vehicle communication using a communication function at regular intervals, and transmit information on the state and surroundings of each vehicle to each other. Thus, in the display area X, the location information 10E regarding the current location of the registered vehicle acquired by the communication function is displayed in place of the registered vehicle image 10B. In the location information 10E, the letter “I am 2 km before” is displayed in the balloon to indicate the current location of the registered vehicles.

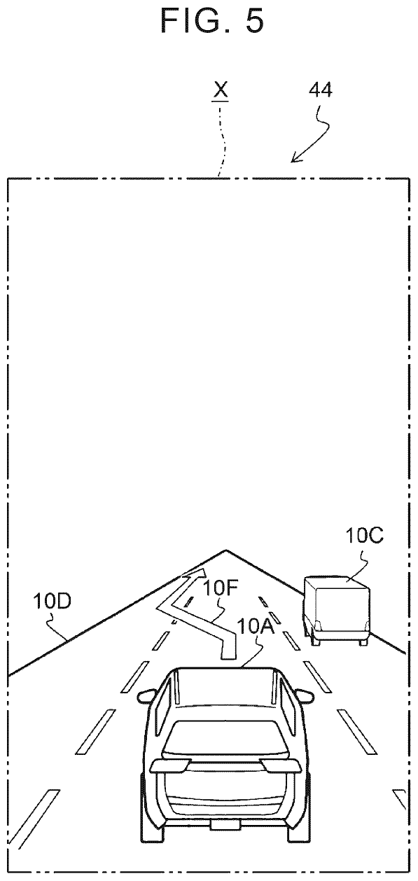

FIG. 5 is a third explanatory diagram illustrating a display example displayed in the display area X of the monitor 44.

In the display area X illustrated in FIG. 5, the registered vehicle image 10B cannot be displayed on the monitor 44 on the basis of the surroundings information by the vehicle 10, and thus the registered vehicle image 10B is deleted. As described above, the vehicle 10 and the registered vehicle perform vehicle-to-vehicle communication using the communication function at regular intervals, and transmit information on the state and the surroundings of each vehicle to each other. Thus, in the display area X, instead of the registered vehicle image 10B, the trajectory information 10F related to the travel trajectory of the registered vehicle acquired by the communication function is displayed. The trajectory information 10F indicates a travel trajectory of the registered vehicles by arrows on the road image 10D. For example, according to the trajectory information 10F, the occupant of the vehicle 10 can recognize that the registered vehicle has traveled straight by changing the lane from the center lane on which the vehicle 10 is traveling to the left lane.

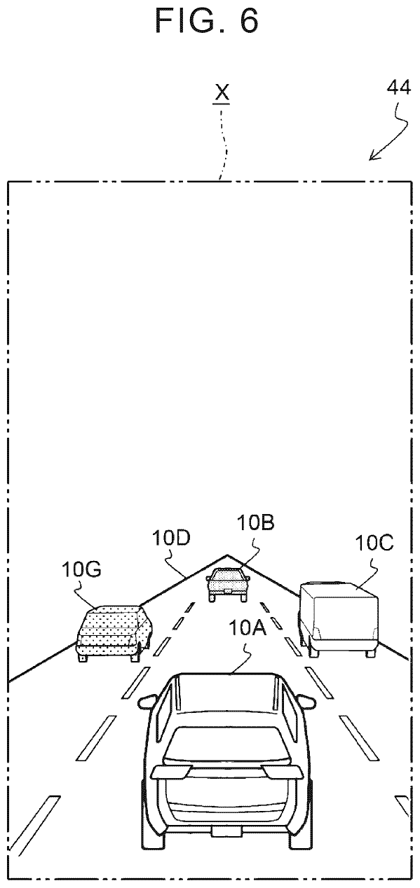

FIG. 6 is a fourth explanatory diagram illustrating a display example displayed in the display area X of the monitor 44.

In the display area X shown in FIG. 6, other-vehicle images 10G are additionally displayed in the display area X shown in FIG. 3. The other-vehicle image 10G is an image indicating a different vehicle than the registered vehicle located on the forward side of the left lane of the vehicle 10. In other words, the other-vehicle image 10G is an image indicating another vehicle that is not registered as a registered vehicle in the vehicle 10.

Here, a pattern that differs from the registered vehicle image 10B is given to the other-vehicle image 10G illustrated in FIG. 6. At this time, CPU 21 assigns the pattern shown in FIG. 6 to the other-vehicle image 10G which has been expressed in white based on an operation on the other-vehicle image 10G displayed on the monitor 44, for example, a touch operation by a finger of an occupant of the vehicle 10. Then, CPU 21 transmits the other-vehicle information indicating the other vehicle designated by the other-vehicle image 10G designated based on the touching operation to the registered vehicle by the communication function. The other-vehicle information includes various types of information such as a vehicle name, a vehicle type, a dimension, a shape, a color, and a vehicle registration number of the other vehicle. At this time, the control device that controls the in-vehicle device of the registered vehicle may change the display mode of the image indicating the other vehicle specified by the other-vehicle information based on the acquisition of the other-vehicle information. For example, the control device may assign a pattern similar to the other vehicle image 10G shown in FIG. 6 to an image showing the other vehicle being displayed on the monitor of the registered vehicle. In addition, the control device may output, based on the acquisition of the other-vehicle information, the fact that the specific other vehicle indicated in the other-vehicle information is approaching from the speaker as the in-vehicle device by voice. As described above, according to the inter-vehicle communication system of the present embodiment, the occupant of the vehicle 10 can notify the occupant of the registered vehicle of the presence of a specific other vehicle (e.g., an emergency vehicle).

As described above, in the meter ECU 20, CPU 21 displays the host vehicle image 10A and the surroundings image viewed from the virtual viewpoint on the monitor 44 based on the surroundings information. When a registered vehicle is detected based on the surroundings information, CPU 21 displays the registered vehicle image 10B on the monitor 44 in a manner different from an image indicating another vehicle different from the registered vehicle. Thus, according to the meter ECU 20, the presence of the registered vehicle can be recognized by the occupant of the vehicle 10 on the monitor 44 by displaying the registered vehicle image 10B on the monitor 44 differently from the image indicating the other vehicle.

Further, in the meter ECU 20, when the registered vehicle image 10B cannot be displayed on the monitor 44 based on the surroundings information, CPU 21 deletes the registered vehicle image 10B from the monitor 44 and causes the monitor 44 to display location information 10E regarding the current location of the registered vehicle acquired by the communication function. Thus, according to the meter ECU 20, even if the registered vehicle image 10B cannot be displayed on the monitor 44, the occupant of the vehicle 10 can continue to grasp the current location of the registered vehicle on the monitor 44.

Further, in the meter ECU 20, when the registered vehicle image 10B cannot be displayed on the monitor 44 based on the surroundings information, CPU 21 deletes the registered vehicle image 10B from the monitor 44 and causes the monitor 44 to display the trajectory information 10F regarding the travel trajectory of the registered vehicle acquired by the communication function. Thus, according to the meter ECU 20, even if the registered vehicle image 10B cannot be displayed on the monitor 44, the registered vehicle can be tracked.

Further, in the meter ECU 20, CPU 21 executes a hands-free call to the occupant of the registered vehicle based on the manipulation on the registered vehicle image 10B displayed on the monitor 44. Thus, according to the meter ECU 20, it is possible to easily contact the occupant of the registered vehicles from the monitor 44.

Further, in the meter ECU 20, CPU 21 transmits another-vehicle information indicating the other vehicle designated based on the manipulation of the monitor 44 to the registered vehicle by the communication function. Thus, according to the meter ECU 20, the occupant of the registered vehicle can recognize the presence of a specific other vehicle.

### Others

In the above-described embodiment, the registered vehicle may be the same another vehicle as the destination of the vehicle 10 as the destination acquired by the inter-vehicle communication, in addition to matching the various types of information indicated in the registered vehicle information stored in the storage 24. In this case, the vehicle 10 may be configured to track the registered vehicle as a navigation route. With this configuration, the occupant of the vehicle 10 can track the registered vehicle on the basis of the information on the travel trajectory of the registered vehicle acquired by the inter-vehicle communication, even if the registered vehicle being tracked disappears due to a left-right turn or the like at the intersection and cannot be detected from the surroundings information of the vehicle 10.

In the above-described embodiment, the vehicle 10 and the registered vehicle perform inter-vehicle communication at regular intervals, but the present disclosure is not limited thereto, and inter-vehicle communication may not be performed. In this case, CPU 21 of the meter ECU 20 continues to display the registered vehicle image 10B on the monitor 44 while the registered vehicle image 10B can be displayed on the monitor 44 based on the surroundings information, and deletes the registered vehicle image 10B from the monitor 44 when the registered vehicle image 10B cannot be displayed on the monitor 44 based on the surroundings information. Then, unlike the above-described embodiment, CPU 21 does not display the location information 10E or the trajectory information 10F on the monitor 44 instead of the registered vehicle image 10B deleted from the monitor 44.

In the above-described embodiment, CPU 21 of the meter ECU 20 is displayed on the monitor 44 using only the target object present in the forward direction of the traveling direction of the vehicles 10 as the target object images, but the present disclosure is not limited thereto. For example, CPU 21 may display, on the monitor 44, an image indicating another vehicle that is located behind and on the side of the vehicle 10, as a target image, based on the surroundings information.

In the above embodiment, the registered vehicle image 10B is an image indicating another vehicle traveling in the same direction as the vehicle 10, but the present disclosure is not limited thereto. The registered vehicle image 10B may be an image indicating another vehicle traveling in a direction other than the vehicle 10, for example, another vehicle traveling in an oncoming lane. In this case, CPU 21 of the meter ECU 20 adds the patterns shown in FIGS. 3 and 6 to the images showing the registered vehicle represented by the white space being displayed on the monitor 44, based on the fact that the registered vehicle is detected from the surroundings information. Thus, the occupant of the vehicle 10 can recognize that the vehicle has passed the registered vehicle on the basis of the change in the display mode of the image indicating the registered vehicle.

In the above-described embodiment, the monitor 44 is an example of the “display unit”, but the example of the “display unit” is not limited thereto. For example, the “display unit” may be a multimedia display provided above the center console, or may be a head-up display (HUD). When an example of the “display unit” is another display that differs from the monitor 44, an example of the information processing device is an ECU that controls the other display.

In the above-described embodiment, the meter ECU 20 executes the specifying process illustrated in FIG. 2. However, the present disclosure is not limited thereto, and the specifying process may be executed by the meter ECU 20 and other ECU in cooperation with each other. For example, the meter ECU 20 may execute other ECU to acquire the surroundings information in S10 and to detect and determine the registered vehicles in S11, and control of displaying the monitor 44 in S12 and S13.

It should be noted that the identifying process executed by CPU 21 reading the software (program) in the above-described embodiment may be executed by various processors other than CPU. Examples of the processor include a PLD (Programmable Logic Device) that can change the circuitry after manufacturing such as FPGA (Field-Programmable Gate Array). Examples of the processor include a dedicated electric circuit or the like, which is a processor having a circuit configuration designed exclusively for executing a particular process such as ASIC (Application Specific Integrated Circuit). Further, the specifying process may be executed by one of these various processors, or may be executed by a combination of two or more processors (for example, a plurality of FPGA, a combination of CPU and FPGA, and the like) of the same type or different types. Further, a hardware structure of the various processors is, more specifically, an electric circuit in which circuit elements such as semiconductor elements are combined.

In the above-described embodiment, the information processing program 24A is stored (installed) in the storage 24 in advance, but the present disclosure is not limited thereto. The information processing program 24A may be provided in a form recorded in a recording medium of CD-ROM (Compact Disk Read Only Memory) or DVD-ROM (Digital Versatile Disk Read Only Memory). The information processing program 24A may be provided in a form recorded in a recording medium such as a USB (Universal Serial Bus). Further, the information processing program 24A may be downloaded from an external device via a network.

What is claimed is:

1. An information processing device comprising a control unit configured to cause a display unit to display an image showing a host vehicle and surroundings of the host vehicle as viewed from a virtual viewpoint, based on surroundings information regarding the surroundings, and configured to, when a registered vehicle registered in advance is detected, cause the display unit to display an image showing the registered vehicle in a manner different from a manner in which the display unit displays an image showing another vehicle different from the registered vehicle.

2. The information processing device according to claim 1, wherein the control unit is configured to, when the image showing the registered vehicle becomes unable to be displayed on the display unit based on the surroundings information, erase the image showing the registered vehicle from the display unit and cause the display unit to display location information regarding a current location of the registered vehicle acquired by a communication function to perform communication between the registered vehicle and the host vehicle.

3. The information processing device according to claim 1, wherein the control unit is configured to, when the image showing the registered vehicle becomes unable to be displayed on the display unit based on the surroundings information, erase the image showing the registered vehicle from the display unit and cause the display unit to display trajectory information regarding a travel trajectory of the registered vehicle acquired by a communication function to perform communication between the registered vehicle and the host vehicle.

4. The information processing device according to claim 1, further comprising a contact unit configured to take a predetermined measure to contact an occupant of the registered vehicle, based on an operation on the image showing the registered vehicle that is displayed on the display unit that also serves as an operation unit.

5. The information processing device according to claim 1, further comprising a communication unit configured to send another-vehicle information indicating the other vehicle designated based on an operation on the display unit that also serves as an operation unit to the registered vehicle by a communication function to perform communication between the registered vehicle and the host vehicle.
